(19) United States
(12) Patent Application Publication
(10) Pub. No.: US 2019/0191661 A1
(43) Pub. Date: Jun. 27, 2019

(54) LITTER BOX REMOVABLE DEVICES TO ASSIST IN NO MESS CLEANING

(71) Applicant: Jennifer A. Johnson, Bridgewater, NJ (US)

(72) Inventor: Jennifer A. Johnson, Bridgewater, NJ (US)

(21) Appl. No.: 16/253,071

(22) Filed: Jan. 21, 2019

Related U.S. Application Data
(63) Continuation-in-part of application No. 15/635,133, filed on Jun. 27, 2017.
(60) Provisional application No. 62/442,277, filed on Jan. 4, 2017.
(60) Provisional application No. 62/355,672, filed on Jun. 28, 2016.

(51) Int. Cl. A01K 1/01; B65F 1/00

(52) U.S. Cl. CPC A01K 1/011; B65F 1/0013

(57) ABSTRACT

Litter box devices to assist in no mess cleaning including hooks, knobs, clips and a bucket removably attached to the litter box on an inside or outside surface with material selected from the group consisting of double-sided tape, hook and loop, glue, suction cups, screws, snaps, magnets, dual lock re-closable fasteners, removable adhesive strips, and hinges.

This application is a continuation-in-part of U.S. application Ser. No. 15/635,133 filed Jun. 27, 2017 which claims the benefit of U.S. provisional application Ser. No. 62/355,672 filed Jun. 28, 2016 and U.S. provisional application Ser. No. 62/442,277 filed Jan. 4, 2017, all of which are incorporated herein in their entirety by reference.

### FIELD OF THE INVENTION

The present invention relates to litter box removable devices to assist in cleaning the litter box with minimal mess. More specifically, it relates to litter box devices placed on the inside wall of the litter box pan which are held in place by adhesives, tape, magnets, screws and the like, such that a waste bag can be securely fixed to the device to prevent a mess while cleaning.

### BACKGROUND OF THE INVENTION

Cleaning a litter box can be a messy process because litter can fall on the ground as it is moved from the litter box to the trash bag. There always seems to be a gap between the bag and the box where litter falls through the slits of a scooper onto the floor during a cleaning, which makes another mess that needs to be cleaned.

Furthermore, holding the trash bag above the litter box so litter doesn't fall onto the floor is not easy either, since holding the bag open with one hand and scooping out the litter with the other hand is difficult.

There isn't a simple method to make scooping out litter an easy, clean process.

The purpose of the invention is to provide a litter box or related device with hooks on the inside of the litter box that hold onto a waste bag and thereby alleviating the messy problems described above. Knobs or clips can also be used instead of hooks. In an alternate embodiment a plastic or rubber flap and/or bracket can be attached to the inner wall of the litter box which the waste bag hooks onto. This is a simple, quick, inexpensive way to eliminate a problem cat owner's deal with frequently.

In yet another embodiment a bucket with a curved protrusion that is secured and/or hung over the side of the litter pan is provided.

Alternatively, other related devices include a hinged flap with hooks, device with hooks and clips with hooks, all with at least one hook placed on the inside wall of the litter box pan where a waste bag can be fixed too to prevent a mess while cleaning. The width of the hook can vary.

Another purpose of the invention is to provide a method to help prevent the spreading of litter that falls on the ground around houses.

Yet another purpose of the invention is to provide a method to help prevent hardwood floors from being damaged from litter that falls on the ground when someone cleans a litter box.

Another purpose of the invention is to provide a method to help prevent cat litter dust that falls on the floor during a litter box cleaning from being inhaled.

Yet another purpose of the invention is to help eliminate the odor that may linger from the cat litter that falls on the ground during a cleaning.

### SUMMARY OF THE INVENTION

In the present invention, these purposes, as well as others which will be apparent, are achieved generally by providing a removable litter box device to assist in no mess cleaning.

In one embodiment a litter box device to assist in no mess cleaning comprises at least one hook 1 attached to a litter box. The hook 1 has an opening 4 and a bag secured within the opening 4 for placing waste material.

The hook can be attached to the inside surface of the litter box and further comprises a curved downward projection 3. The curved downward projection 3 is attached to the litter box surface.

The hook 1 can be attached to the outside surface of the litter box and further comprises a curved upward projection 8. The curved upward projection 8 is attached to the litter box surface.

In both embodiments the hook 1 is made of plastic, metal, rubber or other similar material. The hook is attached to the litter box with material selected from the group consisting of double-sided tape, hook and loop, glue, suction cups, screws, snaps, magnets, dual lock re-closable fasteners, removable adhesive strips, and hinges.

In an alternate embodiment a bracket 6 can be mounted on the inside of the litter box, wherein the bracket 6 has an opening 7 for insertion of a hook or knob.

The bracket 6 can also be mounted on the outside of the litter box; wherein the bracket 6 has an opening 7 for insertion of a hook or knob.

In another embodiment the hook 1 device is attached to the outside surface of the litter box and further comprises a curved upward projection 8.

The hook itself may further include an opening or hole to further secure the bag to the hook. Once the bag is wrapped around the hook, the bag can be tucked into this opening or hole to further secure it in place.

In another embodiment a litter box device to assist in no mess cleaning comprises at least one knob placed secured to a litter box surface. The knob has a flat top surface 2 and a bottom surface 4 with an upper protruded portion 13; and a bag secured to said knob by wrapping around said upper protruded portion.

The knob is made of plastic, metal, rubber or other similar material. The knob is attached to the litter box on said upper protruded portion 13 with material selected from the group consisting of double-sided tape, hook and loop, glue, suction cups, screws, snaps, magnets, dual lock re-closable fasteners, removable adhesive strips, and hinges.

In another embodiment a litter box device to assist in no mess cleaning comprises at least one peg 9 with a surface 10 that attaches to a litter box surface; and a knob or hook 11 having an opening 11 that fits into the peg 9.

In another embodiment a litter box device to assist in no mess cleaning comprises at least one clip 15 that attached to a litter box surface; such that one side 16 of the clip is attached to the litter box surface and the other side of the clip opens to attach and hold a waste bag. The clip is attached to the litter box with material selected from the group consisting of double-sided tape, hook and loop, glue, suction cups, screws, snaps, magnets, dual lock re-closable fasteners, removable adhesive strips, and hinges

The clip is attached to the litter box surface to either open up or down, depending on user's preference.

The clip is made of plastic, metal, rubber or other similar material.

In another embodiment a litter box device to assist in no mess cleaning comprises a bucket 17 with a curved protrusion 18 which fits securely over a litter box. The bucket 17 includes a bucket opening 21, a handle 18 and a litter scoop holder 20.

In yet another embodiment a litter box having means for attaching a waste bag for no mess cleaning is provided. The attachment means in this embodiment are an integral part of the litter box and include at least one of the following from the group consisting of hooks, knobs, clips and a bucket. The attachment means are either on the litter box on an inside surface or an outside surface.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIGS. 1A to 1F illustrates a litter box hook in accordance with the invention: FIG. 1A is a left side profile view of the device; FIG. 1B is a top profile view of the device; FIG. 1C is a frontal side prospective view of the device; FIG. 1D is a right side profile view of the device; FIG. 1E is a bottom profile view of the device and FIG. 1F is a frontal view of the device;

FIGS. 2A and 2B illustrates hook variation 1 (FIG. 2A) according to the invention which includes a mounted bracket (FIG. 2B);

FIGS. 3A to 3D illustrates hook variation 2 according to the invention; FIG. 3A is a left side profile view of the device; FIG. 3B is a top profile view of the device; FIG. 3C is a right-side profile view of the device; and FIG. 3D is a frontal view of the device;

FIG. 4 illustrates hook variation 3 according to the invention;

FIGS. 5A to 5F illustrates a litter box knob according to the invention; FIG. 5A is a left side profile view of the device; FIG. 5B is a top profile view of the device; FIG. 5C is a back side prospective view of the device; FIG. 5D is a right side profile view of the device; FIG. 5E is a bottom profile view of the device and FIG. 5F is a back side view of the device;

FIG. 6 illustrates a litter box clip according to the invention; and

FIGS. 7A and 7B illustrates a litter box bucket according to the invention; FIG. 7A is a view of one embodiment and FIG. 7B is a view of an alternate embodiment.

### DETAILED DESCRIPTION OF THE INVENTION

The invention describes a number of litter box devices to assist in no mess cleaning. The components of the various embodiments are indicated as follows and shown in the accompanying figures:
1—hook;
2—front surface of hook;
3—curved downward projection on back surface of hook;
4—opening;
5—hook variation 1;
6—bracket;
7—opening for hook insertion;
8—curved upward projection on back surface of hook;
9—peg;
10—surface that attaches to litter box wall surface;
11—knob and/or hook;
12—opening on knob and/or hook that fits into peg;
13—knob;
14—back surface of device;
15—clip;
16—clip surface attaches to litter box wall surface;
17—bucket version 1;
18—curved downward protrusion;
19—handle for bucket;
20—litter scoop holder;
21—bucket opening for waste material; and
22—bucket version 2.

### Litter Box Hook

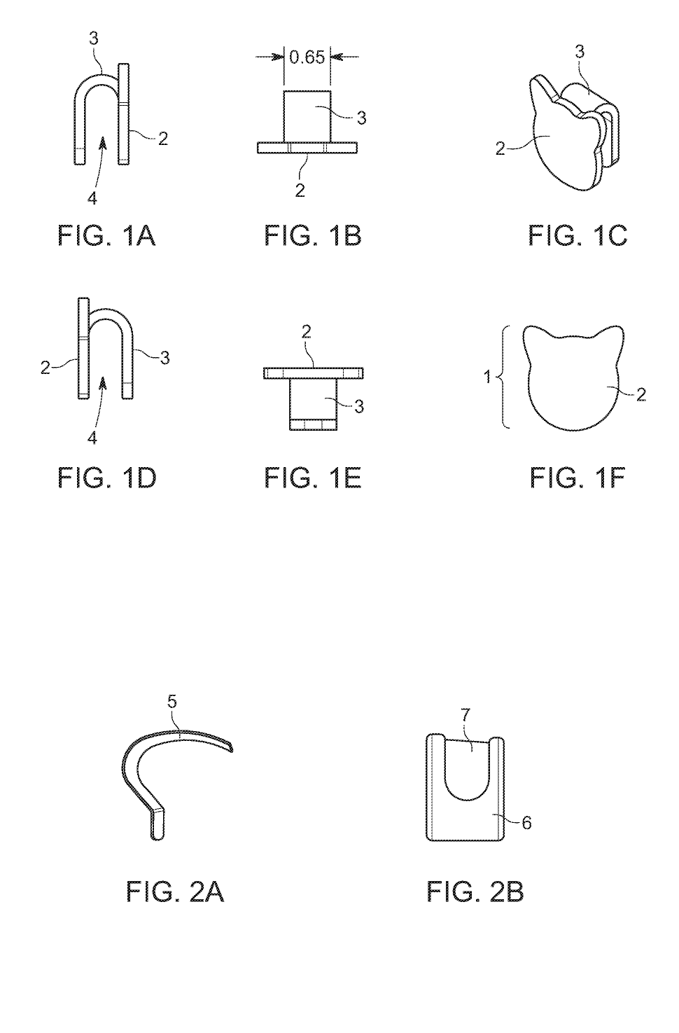

As shown in FIGS. 1A to 1F, at least one, but preferably two or more, hooks are placed inside the litter box to hold one side of a litter bag during a cleaning. The hooks are attached to the litter box wall at a distance that accommodates the user's size litter bag. The hooks are pointed downward and there is space between the litter box and hook so the bag can wrap around the downward facing tip of the hook. In typical applications a hook faces upward, but for the purposes of the invention for cleaning a litter box it points downwards in this embodiment.

In particular, FIG. 1A shows a left-side profile view of the hook 1 device with the front surface 2 and the curved downward projection 3 on the back surface of the hook. The back surface of the curved downward projection 3 is the portion of the hook that is affixed to the litter box surface by means described in more detail below.

FIG. 1B is a top profile view of the device showing the curved downward projection 3 on the back surface of the hook.

FIG. 1C is a frontal side prospective view of the device showing the front surface 2 the curved downward projection 3 and the opening 4 for securing the waste bag.

FIG. 1D is a right-side profile view of the device, similar to FIG. 1A and showing the same elements.

FIG. 1E is a bottom profile view of the device illustrating the bottom view of the curved downward projection 3; and FIG. 1F is a frontal view of the device. The hook can have shapes, such as a cat face (as illustrated), or any other decorative feature for marketability. The device is not limited to any particular design feature.

The embodiment shown in FIG. 1 is preferably mounted on the inside of the litter box. The curve, length/width of hook, distance the hook extends from the box wall, can vary. Preferably, the front of the hook can curve upward to a 90° angle. The length of the hook can extend into the litter box to approximately 5 inches. If the hook is longer than 5 inches, it may interfere with the cat's use of the litter box and not securely hold the waste bag to the hook. The width of the hook can vary from ⅛″ to 14″ depending on how many hooks are being utilized.

The hooks can be made of plastics, metals, rubber, or any suitable material.

The hook(s) can also be mounted to the outside wall of the litter box in a normal hook position and the bag will wrap around the upward facing tip.

Variations of the hooks used in the invention are described below but are not meant to be limiting in any manner.

### Hook Variation 1

A bracket 6 as shown in FIG. 2B can be mounted to the inside or outside of the litter box wall that will allow the user to remove the hook 5 illustrated in FIG. 2B after a cleaning and insert them again before a cleaning begins.

The hook in FIG. 2 is preferably mounted on the outside of the litter box. The hook shown is a long hook which reaches over the litter box rim and extends down into the litter box. Thus, the hook in this embodiment is curved in a downward position inside the litter box for securing a waste bag.

All other hooks described in the invention, if mounted on the outside of the box, are flipped to an upward position.

The bracket 6 has an opening 7 for the hook 5 to be inserted and secured. The opening is preferably on the top of the bracket so that the hook just slides down and locks in place. It is easily removed by the opposition action of lifting it up and out of the bracket. The bracket can be ⅛″ up to 14″ wide, depending on how many hooks are being used.

The bracket 6 can be used with all hooks, knobs and clips described in the invention. The bracket is secured to the desired surface and the device are easily secured within the bracket and removed when needed.

The waste bag is then secured in place over this hook 5 with the waste bag hanging outside of the litter box but because of the invention device there is no spillage of litter or waste when scooping out.

Multiple brackets and hooks can be added as needed to the litter box.

### Hook Variation 2

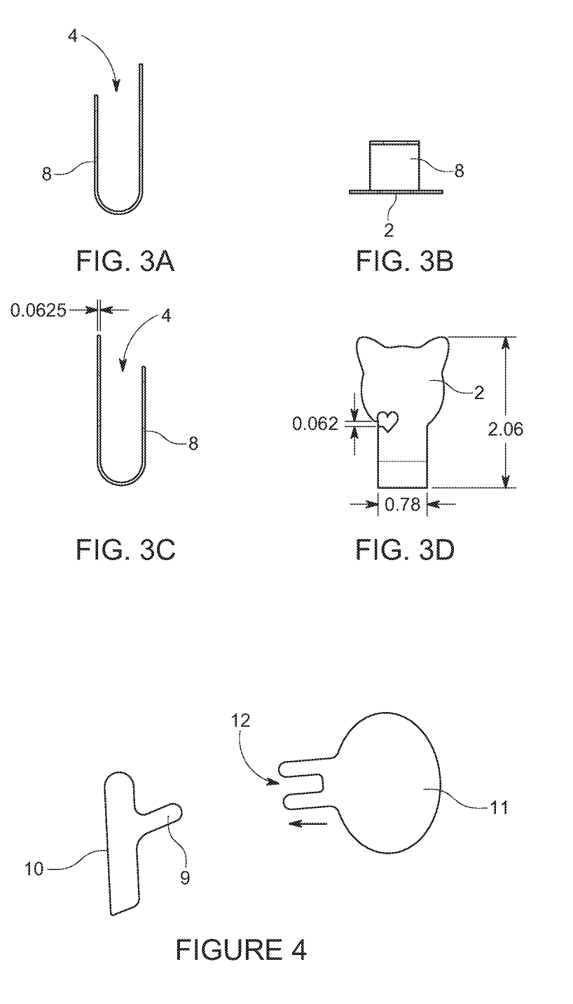

As shown in FIGS. 3A to 3D, the hooks may have slit(s) or opening(s) 4 that allow the user to further secure the bag to the hook. The slits/openings can be different shapes and sizes. For example, the bag can be wrapped around the hook and then stuffed inside the opening to better secure the bag. The openings/slits are not longer than half the width of the hook, otherwise the hook may break when pressure is applied.

FIG. 3A is a left side profile view of the device showing the curved upward projection 8 on the back surface of the hook with opening 4 for the waste bag to secure to. The outer surface 8 is attached to the litter box surface wall. The front surface 2 is used to secure the waste bag. FIG. 3B is a top profile view of the device showing the curved projection 8 extending from the back surface of the hook. FIG. 3C is a right-side profile view of the device similar to FIG. 3A and FIG. 3D is a frontal view of the device. In a preferred embodiment the hook is approximately 2 inches high by ¾ inches wide by ½ inch deep.

The hook in this variation is attached to the litter box in the same manner as in all embodiments of the invention. All hooks and variations are attached to the litter box on one surface, with double sided tape, screwed into the litter box, hook and loop, glue, suction cups, snaps, magnets, dual lock, re-closable fastener, removable adhesive strips, or part of the litter box mold. Products commercially available as Command™ mounting strips or adhesive strips from 3M can be used in the invention as well as 3M Dual-Lock™ re-closable fasteners. 3M™ Dual Lock™ reusable fasteners provide a bond that has five times the holding power of hook-and-loop fastener and come in the convenience of pre-cut strips in various sizes and with different adhesives for multiple applications. These fasteners are often used as a fastening system in retail stores on shelf tag holders, talkers, signs and label mounts. In all embodiments, with the exception of the litter box molds, the invention devices, while they are fixed securely in place are removable. The adhesive or other attachment means are removable with the device being removed for cleaning the litter box, if so desired. The device can then be re-attached in the same position or in a new one, depending on the user's preference.

### Hook Variation 3

As shown in FIG. 4, a peg 9 can be mounted to the litter box wall 10. A knob or hook 11 having an opening 12 on it's surface is provided. This opening 12 fits snugly into the peg 9 to hold the hook or knob securely in place. The waste bag is secured over the knob or hook.

### Litter Box Knob

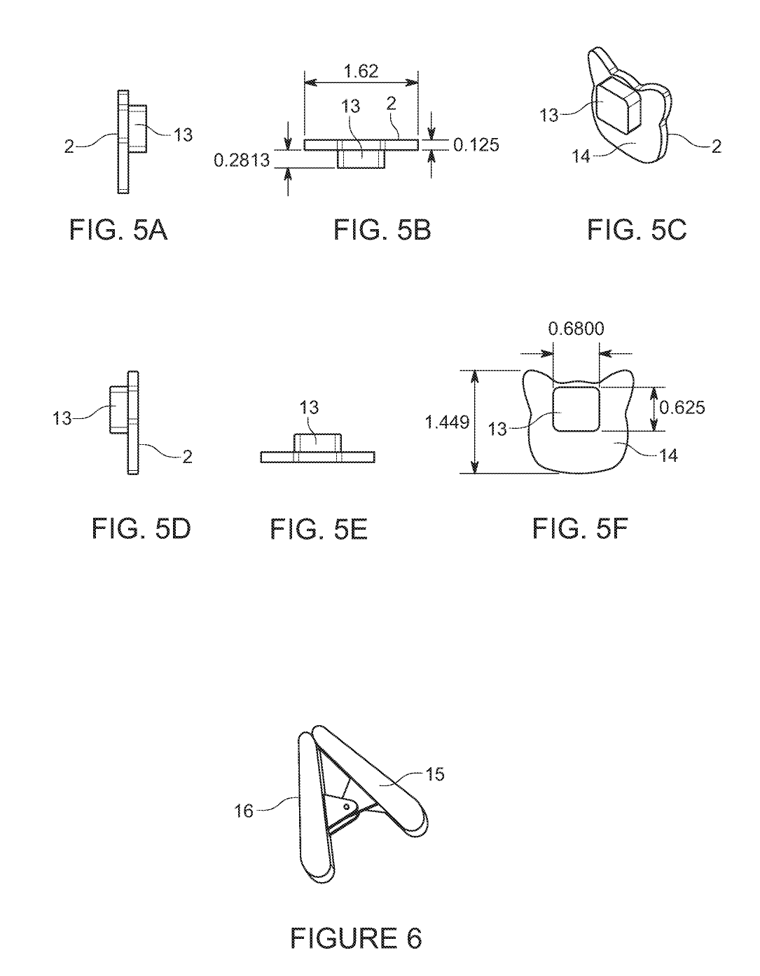

As shown in FIGS. 5A to 5F, at least one, but preferably two or more, knobs are placed inside the litter box to hold one side of a litter bag during a cleaning. The knobs are attached to the litter box at a distance that accommodates the user's size litter bag. There is space between the litter box and knob(s) so the bag can wrap around the knob(s). Although, space is desirable and works well to anchor the bag, it is not absolutely necessary. Usually an object wraps around the top part of a knob, but for cleaning a litter box, the bag is wrapped around the bottom of the knob. The size, distance knob hook extends from the box, and shape of the knob can vary. The hook can have shapes, such as a cat face, for marketability.

FIG. 5A is a left side profile view of the device showing the knob 13 element fixed to the back side of surface 2. FIG. 5B is a top profile view of the device showing the knob 13.

FIG. 5C is a back side prospective view of the device showing the back surface 14 of the device where the knob 13 itself covers only a portion of this surface 14.

FIG. 5D is a right-side profile view of the device similar to FIG. 5A. FIG. 5E is a bottom profile view of the device showing the knob 13 and FIG. 5F is a backside view of the device. As, illustrated the knob is only a fraction of the size of the back surface 14 and protrudes therefrom. The knob is shown as a rectangular shape but could be square or circular or any other shape. The backside of the knob surface is affixed to the litter box wall either as an inside mount or an outside mount. The waste bag is secured in place over this knob.

The knobs can be made of plastics, metals, rubber, or any suitable material.

The knob(s) can also be mounted to the outside wall of the litter box and the bag will wrap around the top half of the knob.

### Knob Variation 1

A bracket can be mounted to the inside or outside of the litter box wall. In this embodiment the bracket is attached to the litter box wall and the knob is secured within the bracket. This allows the user to remove the knobs after a cleaning and insert them again before a cleaning begins.

### Knob Variation 2

The knobs may have slit(s) or opening(s) that allow the user to further secure the bag to the hook. The slits/openings can be different shapes and sizes. This is similar to the hook variation 2 embodiment illustrated in FIG. 3.

### Knob Variation 3

Pegs can be mounted to the litter box wall, and the knobs can have a hollow inside into which the peg is inserted as described above in the hook variation 3 embodiment and illustrated in FIG. 4.

All knobs and variations can be attached with double sided tape, screwed into the litter box, hook and loop, glue, suction cups, magnets, snaps, dual lock re-closable fastener, removable adhesive strips, hinges, or part of the litter box mold.

### Litter Box Clip

As shown in FIG. 6 one or more clips 15 (similar to a chip clip or clothespin) can be mounted to a litter box wall and used to hold a litter bag during a cleaning. The clip opening can be positioned either upwards or downwards when mounted on the inside or outside of the litter box wall. The clip can have shapes, such as a cat face, for marketability. The clip shape can vary and include many decorative shapes.

The back side of the clip 16 is attached to the litter box wall with double sided tape, screwed into the litter box, hook and loop, glue, suction cups, magnets, dual lock rec-losable fastener, snaps removable adhesive strips, hinges, or part of the litter box mold.

The clips may have an opening(s) that allow the user to further secure the bag to the hook. This opening allows the bag to be tucked into the slits/openings to be further secured to the device. The opening can be different shapes and sizes.

All variations can also be attached to the top, underside, or edge of the “rim” or edge that is commonly goes along the top of the litter box walls. This means it is likely that part of the hook, knob, or clip would extend into the litter box.

### Litter Box Bucket

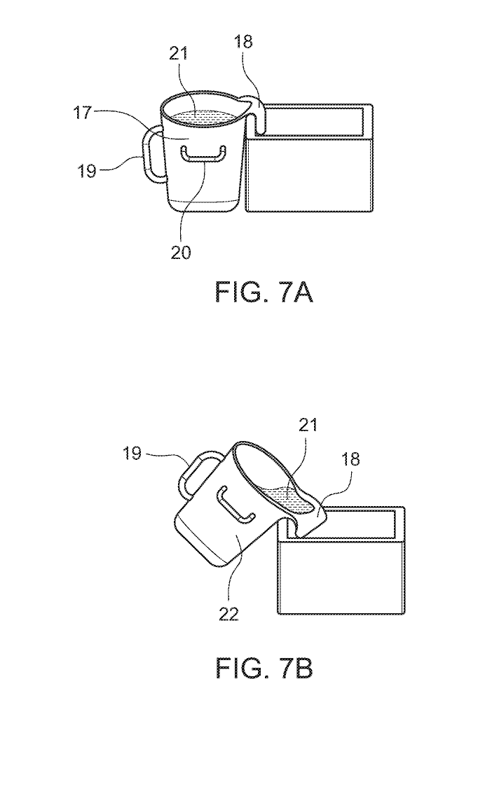

As shown in FIGS. 7A and 7B the bucket serves the same purpose as the attachments described above which is to eliminate the space where litter can fall on the floor during a cleaning.

The bucket will have one side that is elongated vertically and curves downward 18.

The curved side of the bucket 18 goes over the rim of a litter box and into the litter box. The curved part of the bucket can have “sides” to better prevent litter from rolling out of the bucket when cleaning.

The shape of the bucket can vary. FIG. 7A shows bucket version 1 which is an upright bucket and FIG. 7B shows bucket version 2 which is an elongated bucket. Both embodiments have an opening 21 for waste material.

The bucket can have handle(s), 19 a non-skid surface on the outside bottom, such a rubber and a hook 20 to store a litter box scooper.

The bucket can also have clips, hooks, knobs, for a plastic bag to attach to if one is used to line the bucket.

The bucket can just hang over the side of the litter box or can be attached to the litter box with double sided tape, screwed into the litter box, hook and loop, glue, suction cups, magnets, dual lock re-closable fastener, snaps removable adhesive strips, hinges, or part of the litter box mold.

The invention also includes a litter box which has been made by injection molding and has means for attaching a waste bag for no mess cleaning. The means are an integral part of the litter box and include at least one of the following from the group consisting of hooks, knobs, clips and a bucket. These components can be either on the litter box on an inside surface or an outside surface.

Preferably the hooks have a curved pointed tip such that the tip is in a downward position. This is so a waste bag can be attached and secured to the hooks while the box is being cleaned. The tip of the hook while pointed is actually rounded so to secure the bag but not to puncture the bag when in place.

In an alternate embodiment, the litter pan and hooks and other devices are an integral structure that has been molded as one continuous material. The advantage of a unitary integral structure would prevent the hooks from breaking or falling off. The invention devices would essentially be molded into the litter box itself during the manufacturing process.

All embodiments described can be made with one wide hook.

The components of the invention are made of plastic, recycled plastic, rubber, or metal materials. Preferably the pan and hooks are made of plastic.

The invention eliminates the gap between the bag and the box where litter would fall though. A person can easily hold the bag open with one hand and scoop out the litter with the other.

Possible variations include different shaped hooks to optimize the ability of the waste bag to stay attached to the inside wall of the litter box. Other variations include different numbers of hooks (one or more total) inside the litter box wall to accommodate different size trash bags. The hooks can be deeper to better grasp a bag and may need to be part of the mold used to create a litter box. The hooks are attached to the litter box with a form of double-sided tape and that will not stay attached as well as hooks that are actually part of the litter box's manufactured mold. The same attachments means can be used if knobs and clips are used in place of hooks.

Other variations include kits with different devices such as clips, knobs and hooks which can be removably attached to a litter box surface. While the attachment means used in the invention are secured in place it is understood that in all embodiments, with the exception of the integral structure embodiments, the devices can be removed and placed in another area on the litter box surface.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A litter box device to assist in no mess cleaning comprising:
at least one hook 1 attached to a litter box, wherein said hook 1 has an opening 4; and
a bag secured within said opening 4 for placing waste material.

2. The device according to claim 1, wherein said hook 1 is attached to the inside surface of the litter box and further comprises a curved downward projection 3.

3. The device according to claim 2, wherein said curved downward projection 3 is attached to the litter box surface.

4. The device according to claim 1, wherein said hook 1 is attached to the outside surface of the litter box and further comprises a curved upward projection 8.

5. The device according to claim 4, wherein said curved upward projection 8 is attached to the litter box surface.

6. The device according to claim 1, wherein said hook 1 is made of plastic, metal, rubber or other similar material.

7. The device according to claim 1, wherein said hook is attached to the litter box with material selected from the group consisting of double-sided tape, hook and loop, glue, suction cups, screws, snaps, magnets, dual lock re-closable fasteners, removable adhesive strips, and hinges.

8. The device according to claim 1, further comprising a bracket 6 mounted on the inside of the litter box, wherein said bracket 6 has an opening 7 for insertion of a hook or knob.

9. The device according to claim 1, further comprising a bracket 6 mounted on the outside of the litter box; wherein said bracket 6 has an opening 7 for insertion of a hook or knob.

10. The device according to claim 1, wherein said hook 1 is attached to the outside surface of the litter box and further comprises a curved upward projection 8.

11. The device according to claim 1, wherein said hook further comprises an additional opening to further secure the bag to the hook.

12. A litter box device to assist in no mess cleaning comprising:
at least one knob placed secured to a litter box surface, wherein said knob has a flat top surface 2 and a bottom surface 4 with an upper protruded portion 13; and
a bag secured to said knob by wrapping around said upper protruded portion.

13. The device according to claim 12, wherein said knob is made of plastic, metal, rubber or other similar material.

14. The device according to claim 12, wherein said knob is attached to said litter box on said upper protruded portion 13 with material selected from the group consisting of double-sided tape, hook and loop, glue, suction cups, screws, snaps, magnets, dual lock re-closable fasteners, removable adhesive strips, and hinges.

15. A litter box device to assist in no mess cleaning comprising:
at least one peg 9 with a surface 10 that attaches to a litter box surface;
and a knob or hook 11 having an opening 11 that fits into said peg 9.

16. A litter box device to assist in no mess cleaning comprising:
at least one clip 15 that attached to a litter box surface; such that one side 16 of the clip is attached to the litter box surface and the other side of the clip opens to attach and hold a waste bag; wherein said clip is attached to said litter box with material selected from the group consisting of double-sided tape, hook and loop, glue, suction cups, screws, snaps, magnets, dual lock re-closable fasteners, removable adhesive strips, and hinges

17. The device according to claim 16, wherein the clip opens either up or down.

18. The device according to claim 16, wherein said clip is made of plastic, metal, rubber or other similar material.

19. A litter box device to assist in no mess cleaning comprising:
a bucket 17 with a curved protrusion 18 which fits securely over a litter box;
wherein said bucket 17 includes a bucket opening 21, a handle 18 and a litter scoop holder 20.

20. A litter box having means for attaching a waste bag for no mess cleaning, wherein said means are an integral part of the litter box and include at least one of the following from the group consisting of hooks, knobs, clips and a bucket, such that the means are either on the litter box on an inside surface or an outside surface.
